(19) United States
(12) Patent Application Publication
(10) Pub. No.: US 2014/0129782 A1
(43) Pub. Date: May 8, 2014

(54) Server Side Distributed Storage Caching

(71) Applicant: Robert Quinn, Campbell, CA (US)

(72) Inventor: Robert Quinn, Campbell, CA (US)

(21) Appl. No.: 13/668,295

(22) Filed: Nov. 4, 2012

(51) Int. Cl. G06F 12/08

(52) U.S. Cl. 711/141; 711/E12.026

(57) ABSTRACT

The invention provides a system with storage cache with high bandwidth and low latency to the server, and coherence for the contents of multiple memory caches, wherein locally managing a storage cache situated on a server is combined with a means for globally managing the coherency of storage caches of a number of servers. The local cache manager delivers very high performance and low latency for write transactions that hit the local cache in the Modified or Exclusive state and for read transactions that hit the local cache in the Modified, Exclusive or Shared states. The global coherency manager enables many servers connected via a network to share the contents of their local caches, providing application transparency by maintaining a directory with an entry for each storage block that indicates which servers have that block in the shared state or which server has that block in the modified state.

### RELATED APPLICATIONS

This application is related to and claims priority from U.S. provisional 61/628,836, of the same title and by the same inventor, filed Nov. 7, 2011, the entirety of which is incorporated by reference as if fully set forth herein.

### FIELD OF USE

The field of use is data center storage systems, and in particular, distributed storage caching.

### BACKGROUND

Data Storage in Enterprise Datacenters is performed by centralized storage systems such as those produced by EMC, Hitachi, NetApp, IBM. In order to improve the response time (latency) and bandwidth the storage system is equipped with a cache that stores the most frequently accessed data. The cache is built, for example, from DRAM or FLASH memory, and such memory has much lower latency than spinning magnetic disks. Such a cache is much more expensive than disk memory. However, in many cases, a cache whose size is a small percentage of the total storage system size can respond to a much larger percentage of the storage requests due to temporal and spatial locality effects.

With the centralized storage system described above, a large number of servers access a much smaller number of storage systems. This means that the performance of the storage system as measured in the number of operations it can perform per second is shared by all servers so the performance per server is small. The bandwidth of data that the storage system can provide is limited by many elements, including the number of connections from the storage system to the interconnecting network. For example, if 100 servers connect to a storage system that has 10 connections to the network and each server has only one connection to the network, then the average storage bandwidth available to each server is only 10% of the bandwidth of its single network connection. Every storage operation initiated by a server must cross the network to the storage system and the response of the storage system must likewise cross the network, which adds to the latency seen by the server.

Referring to FIG. 1, which depicts current storage side caching, the benefits and shortcomings are well known. Such a conventional storage side caching configuration provides location transparency, i.e. if an application moves from Server X to Server Y, the application continues to correctly see all of the application's storage data. And the configuration provides low cost per server: the cache in the storage array ca cache data from all connected servers.

Drawbacks and shortcoming of the conventional storage side caching: the storage system cannot provide high bandwidth to the servers because all “reads” and “writes” must go across the connecting network. Further, it cannot provide the lowest latency, because cache hits must go across the connecting network.

As can be seen by referring to FIG. 2, server side caching is an alternative to storage side caching. However, although server side caching configurations are theoretically possible, the problem of data coherency has not been addressed. Server side caching provides high bandwidth and low latency to the server. However, drawbacks include:
a) lack of location transparency: if an application movers form server X o server y, all writes to the cache in server x which have not been flushed to the storage array are lost
b) inefficiency: data cached by an application in server X is private to server X
c) high cost: cache in server x must be large as it cannot use the resources of the cache in server Y

What is needed is a storage cache that provides high bandwidth and low latency to the server, and which also provides coherence for the contents of multiple memory caches.

### BRIEF SUMMARY OF THE INVENTION

The invention meets at least all the unmet needs recited hereinabove. The invention provides a system with storage cache with high bandwidth and low latency to the server, and coherence for the contents of multiple memory caches.

The invention provide for placing the cache in the server and allow any server to access the contents of another server's cache while maintaining global data coherency. This means that even though the size of each cache is small (for cost reasons as there is one in each server) the total cache available is large and can be as large as and larger than the size of the traditional caches in the storage systems. Placing a cache in each server provides a large total number of operations per second, provides a large total bandwidth, and provides the lowest latency as many storage operations can be satisfied from the cache inside the server without crossing the network. In a nutshell, distributing the cache across all servers means that the performance scales with each additional server.

The inventive embodiment solves the problem of keeping the multiple server caches coherent while maintaining high performance by having some state transitions managed locally on the server by the Server Storage Cache Controller and having the remaining state transitions managed by a Global Coherency Manager. The combination of the Server Storage Cache Controller and the Global Coherency Manager maintains a coherency state for each block such that the state of the system as seen by an application running on a server appears identical to the state of a system with no caching. These states and state transitions are managed by a combination of the logic in each server and by the logic in a global coherency manager. When so partitioned, the server and its Server Storage Cache Controller can operate correctly without the Global Coherency Manager when the data that is cached is not shared with any other server, and so operate in a legacy mode.

The invention provides a means of locally managing a storage cache situated on a server combined with a means for globally managing the coherency of storage caches of a number of servers. The local cache manager provides a means to deliver very high performance and low latency for write transactions that hit the local cache in the Modified or Exclusive state and for read transactions that hit the local cache in the Modified, Exclusive or Shared states, as these can all be completed locally without the need to communication outside the server. The global coherency manager provides a means for many servers connected via a network to share the contents of their local caches, (providing application transparency meaning applications can move between servers while maintaining a coherent view of storage and maintaining the performance benefits of storage caching) by maintaining a directory with an entry for each storage block that indicates which servers have that block in the shared state or which server has that block in the modified state.

According to the invention, a Global Coherency Manager maintains a queue [Q] of Transactions in Flight such that ordering of colliding transactions is resolved based on which one entered the Queue first. When an arriving transaction collides with a transaction already in the Queue, it is blocked from proceeding until the earlier transaction completes which is indicated by it being removed from the Queue.

### BRIEF DESCRIPTION OF THE DRAWINGS

The following drawings are provided as an aide to understanding the invention:

FIG. 1 depicts a current approach

FIG. 2 depicts a current approach

FIG. 3 depicts a generalized embodiment according to the invention

FIGS. 4-12 depict operations as performed according to an inventive embodiment

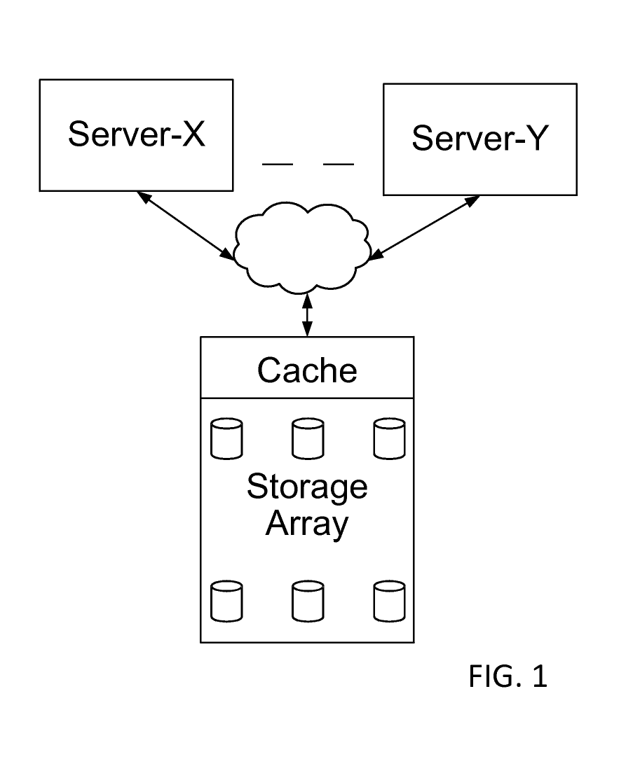

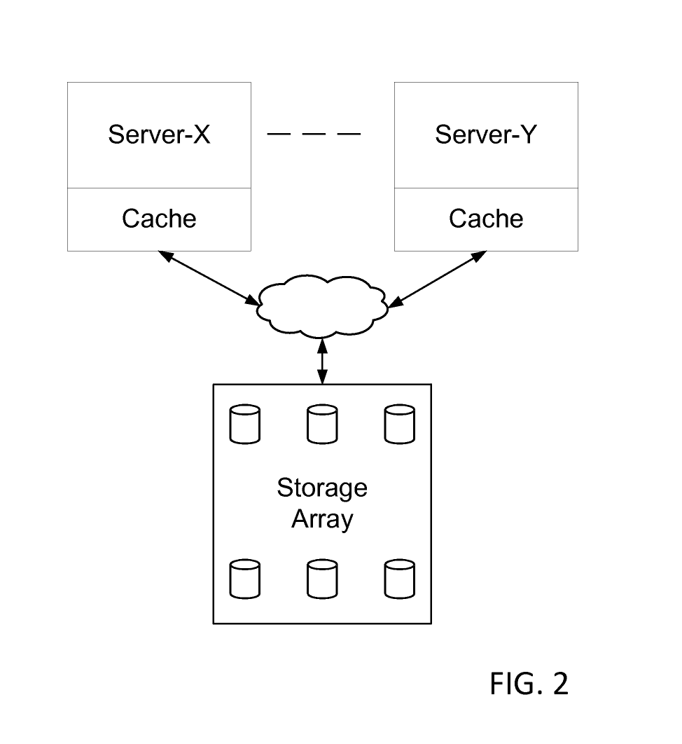

### DETAILED DESCRIPTION OF A PREFERRED EMBODIMENT

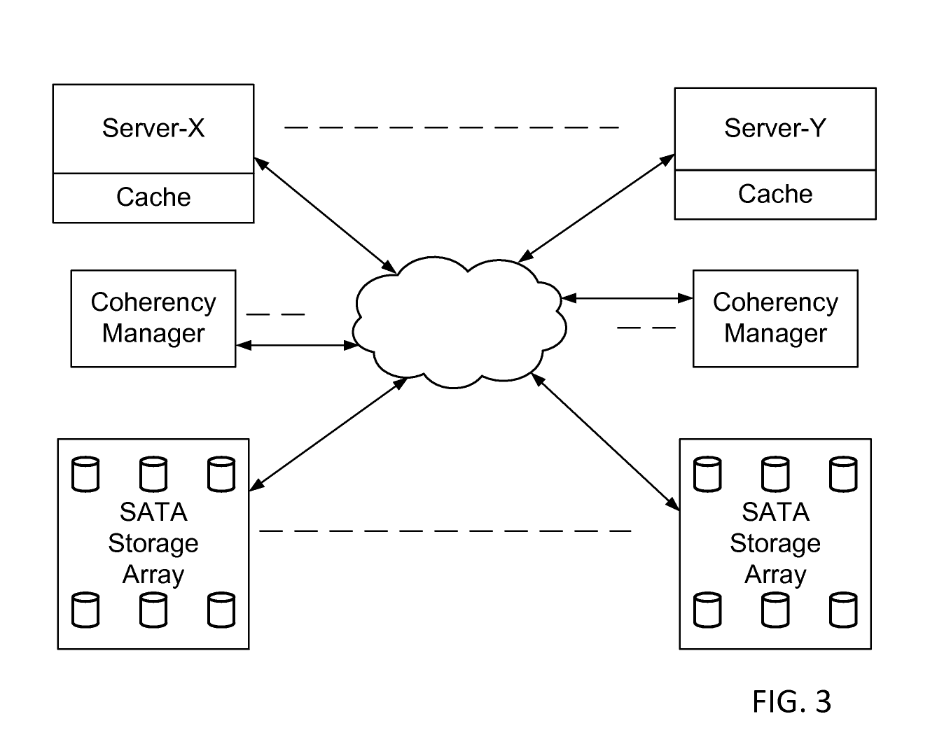

FIG. 3 depicts a generalized embodiment of the invention. A system according to the invention comprises: two or more servers, each server equipped with a resident memory cache, and each server connected to each other, to a storage array, and to a coherency manager. Each resident memory cache (also referred to herein as a storage cache controller) is enhanced so as to operate with the coherency manager. The coherency manager is any combination of hardware, software or firmware that can implement computer implementable instructions to maintain coherency of data stored among the resident memory caches and the storage array.

Provided hereinbelow is a description of Server Side Distributed Storage Caching in a datacenter according to an embodiment of the invention.

Each server is equipped with a high bandwidth, randomly accessible storage medium used as a cache for storage blocks such as, for example, a Solid State Disk (SSD) built with Flash Memory. Each server has a storage cache controller that has been programmed with the following information:
What storage it is authorized to cache (e.g. disks, LUNs)
How to perform Reads and Writes to that storage
What Coherency Manager is managing that storage
How to communicate with that Coherency Manager
   The storage cache controller also keeps information on the state of every block that it caches.

When the storage cache controller receives a read or write command from the server where it resides, and if it is authorized to cache that storage, it performs the operations set forth herein.

The storage cache controller looks up the state of the storage block, which can be Modified, Exclusive, Shared or Invalid. The Modified state means that the storage cache controller has the most up to date copy of that block and is authorized to read and write to that block without communicating with the Global Coherency Manager. In addition, it means that the storage cache controller is solely responsible for that block and cannot discard it. The Exclusive state means that the storage cache controller has an up-to-date copy of that block and is authorized to read and write to that block without communicating with the Global Coherency Manager; it can discard that block while in the exclusive state and must upgrade the state to Modified when it writes to that block. The Shared state means that the storage cache controller has a copy of that block and can read from it but it cannot write to it without requesting and being granted permission from the Global Coherency Manager. The Invalid state means that the storage cache controller does not have the block and must send the read or write request to the Global Coherency Manager.

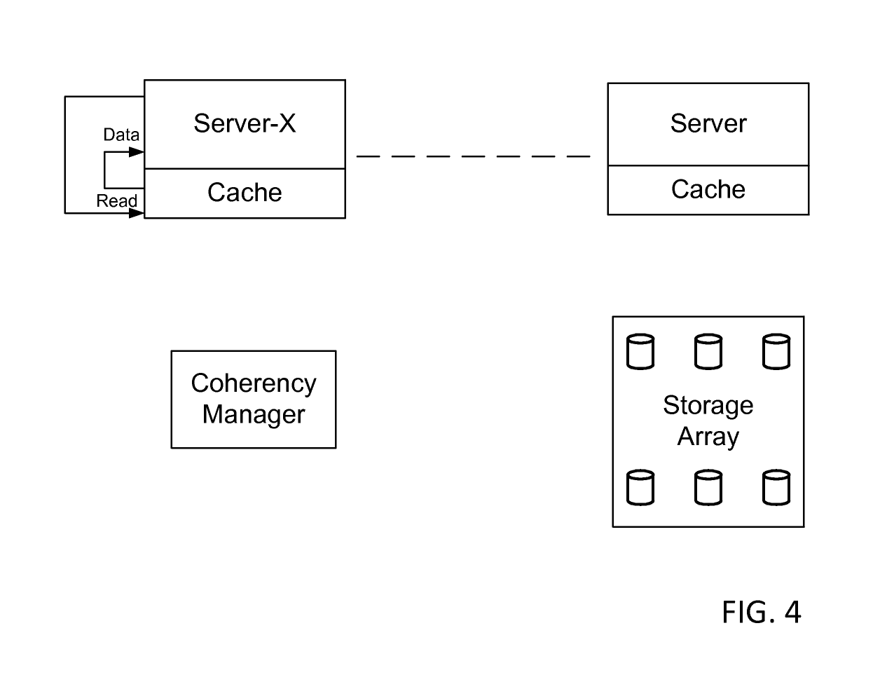

FIGS. 4 through 12 provide illustrations of operations according to the present invention.

As depicted in FIG. 4, a read is issues by the server and the Storage Cache Controller has the block in M/E/S state. The Server issues a read to a storage block. The Storage Cache Controller finds that the block is in its Cache in a Shared or Exclusive or Modified state. It reads it and returns it to the Server and leaves the state unchanged. There is no communication outside Server, so this is a purely local transaction.

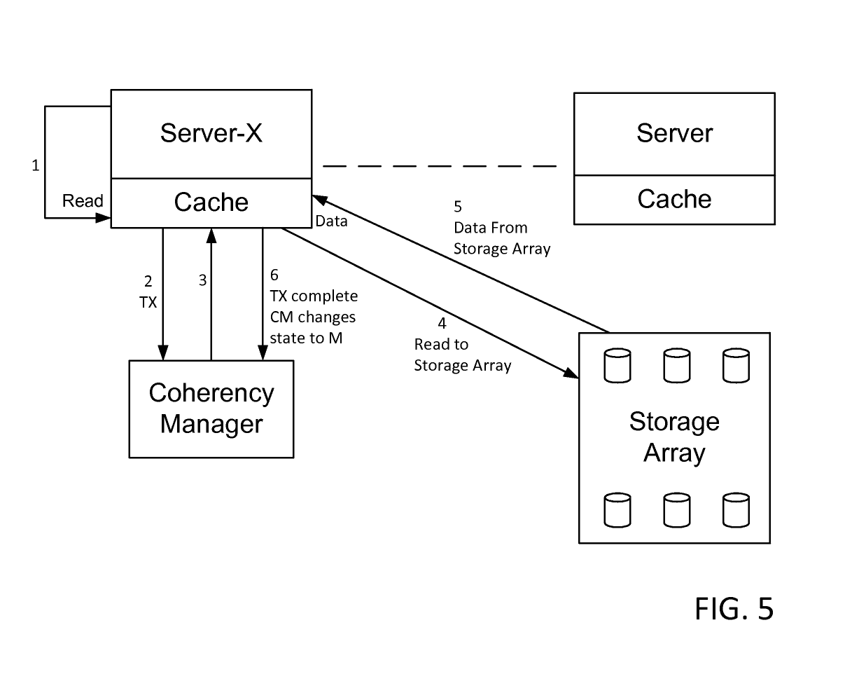

As depicted in FIG. 5, a read is issued by the server and the Storage Cache Controller either has no entry for that block (a miss) and the Coherency Manager has it in the I state. The Server(-X) issues a read to a storage block. The Storage Cache Controller finds that block is not in its Cache and forwards the Transaction to the Coherency Manager which finds the block in the Invalid (I) state. The Coherency Manager replies to Server-X with an Invalid (meaning that none of the other Storage Cache Controllers have a copy of this block) and Server-X sends a read to the Storage Array. The Storage Array returns the read data to Server-X which caches it in the E state. Server-X sends a TX complete to the Coherency Manager which sets the state of the block to M and removes the transaction from a Transaction-In-Process queue. Setting the state to M in the Transaction Manager when the Storage Cache Controller is in the E state is done so that the Storage Cache Controller can transition the state from E to M without communicating outside the server. The Transaction-In-Process queue is the serialization point for resolving transaction collisions. (A collision is when several Storage Cache Controllers initiate transactions to the same storage block). An optimization here is to have the Coherency Manager send the read to the Storage Array on behalf of Server-X.

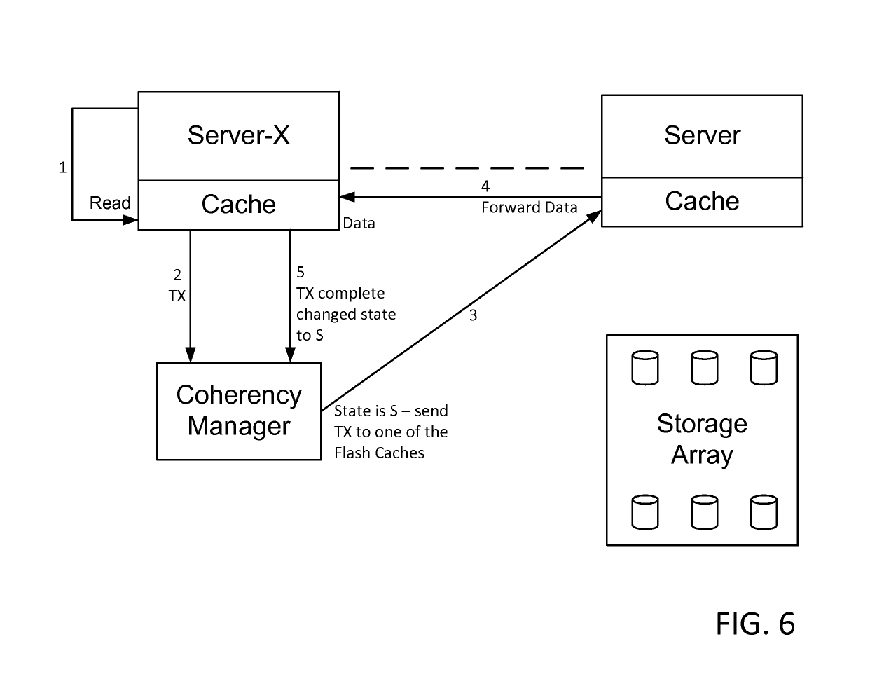

As depicted in FIG. 6, a read is issued by the server and the Storage Cache Controller has no entry for that block (a miss) and the Coherency Manager has it in the S state. The Server-X issues a read to a storage block. The Storage Cache Controller finds that block is not in its Cache and forwards the Transaction to the Coherency Manager which finds the block in the S state. This means that the block is cached by several Storage Cache Controllers and the Coherency Manager has a list of those. The Coherency Manager forwards the Transaction to one of the (possibly many) servers with that block in the S state. When the selected server receives the transaction, it forwards the data to Server-X. The Storage Cache Controller caches that block of data, sets the state to S and completes the original read. The Storage Cache Controller then sends a completion transaction to the Coherency Manager which adds Server-X to the sharing list and removes the transaction from a Transaction-In-Process queue.

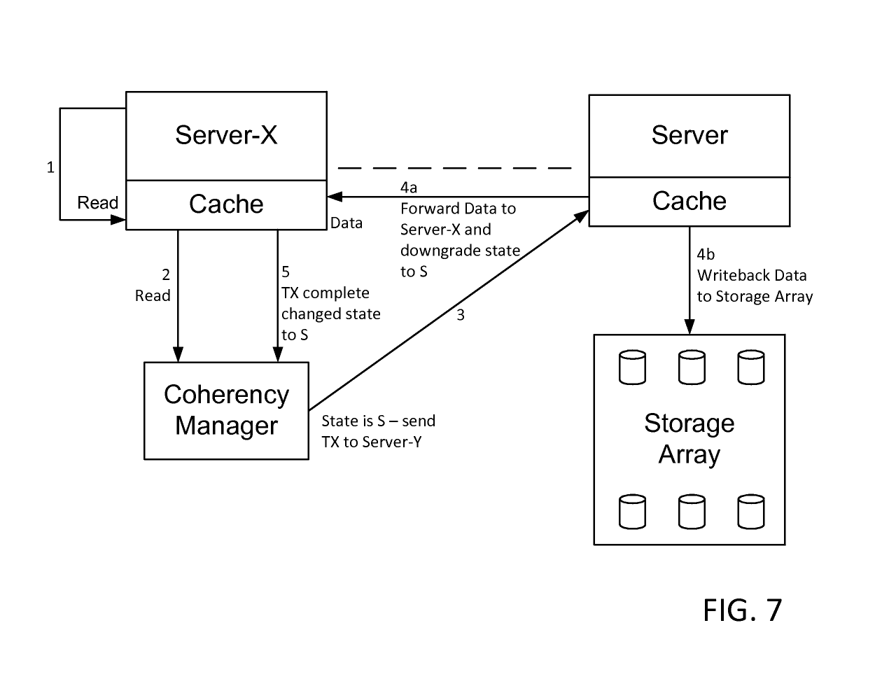

As depicted in FIG. 7, a read is issued by the server and the Storage Cache Controller has no entry for that block (a miss) and the Coherency Manager has it in the M state. The Server-X issues a read to a storage block. The Storage Cache Controller finds that block is not in its Cache and forwards the Transaction to the Coherency Manager which finds the block in the M state. The Coherency Manager forwards the Transaction to the Server with the block in the M state, Server-Y. When Server-Y receives the transaction it looks up the state of the block. Server-Y has the block in the M state and it writes the block back to the Storage Array, downgrades the state to S and forwards the data to Server-X. The Server-X Storage Cache Controller caches that block of data, sets the state to S and completes the original read b y returning the data. The Storage Cache Controller then sends a completion transaction to the Coherency Manager which downgrades the state from M to S, adds Server-X and Server-Y to the sharing list and removes the transaction from a Transaction-In-Process queue.

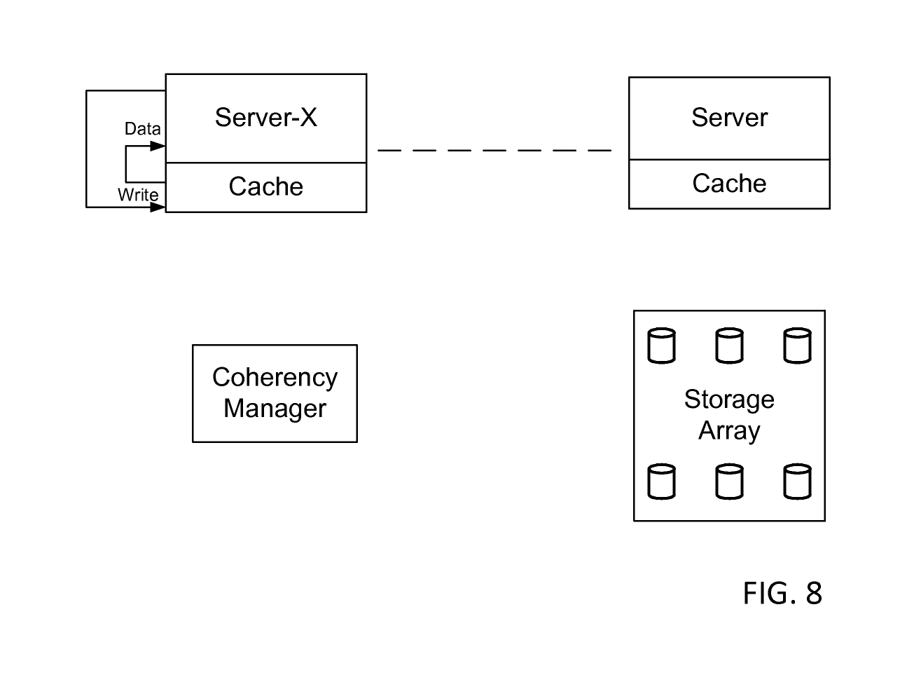

As depicted in FIG. 8, a write is issued by the server and the Storage Cache Controller has the block in the M/E state. Write Hit Transaction. Server-X issues a write to a storage block. The Storage Cache Controller finds that block in its Cache in an Modified or Exclusive state. It writes the data and if the state is E upgrades the state to M. There is no communication outside Server-X.

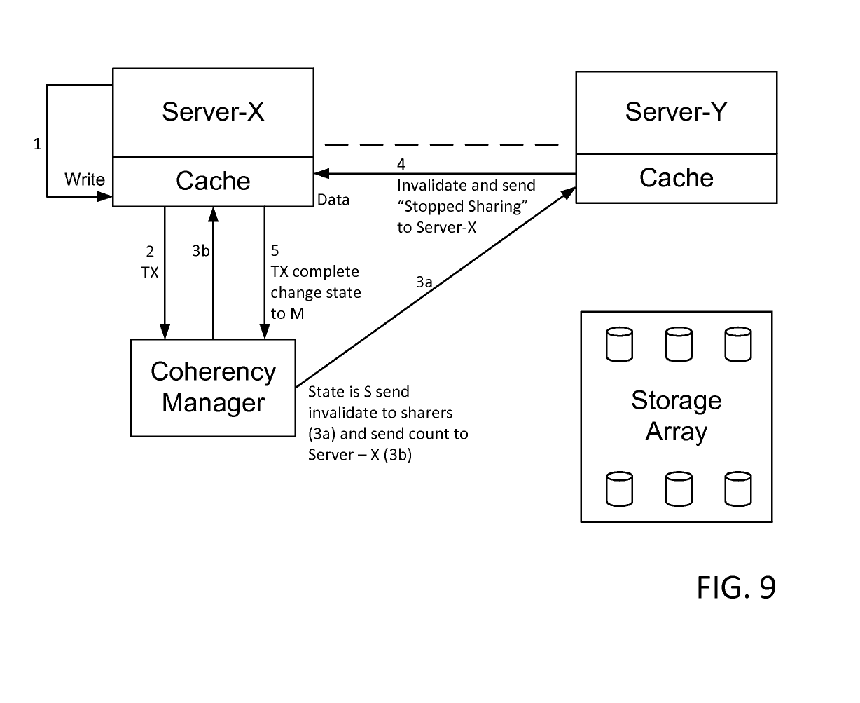

As depicted in FIG. 9, a write is issued by the server and the Storage Cache Controller has the block in the S state and the Coherency Manager has the block in the S state. Server-X issues a write to a storage block. The Storage Cache Controller finds that block in its Cache in a Shared state and forwards the transaction to the Coherency Manager. The Coherency Manager finds that block in the S state and sends an Invalidate to all of the sharers. The Coherency Manager sends a reply to the Storage Cache Controller on Server-X with a share count. The sharers respond to the invalidate from the Coherency Manager by invalidating the block and sending a “Stopped Sharing” transaction to the Storage Cache Controller on Server-X. When the Storage Cache Controller on Server-X has decremented the share count to zero it completes the write to its cache and sends “Transaction Complete” to the Coherency Manager. The Coherency Manager then sets the state to M and removes the transaction from a Transaction-In-Process queue.

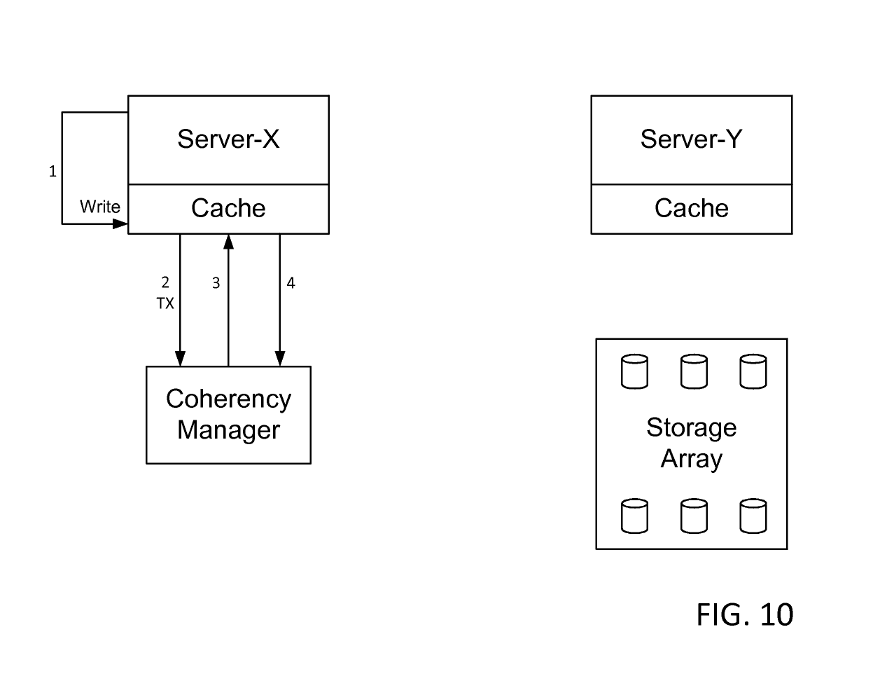

As depicted in FIG. 10, a write is issued by the server and the Storage Cache Controller has no entry for that block (a miss) and the Coherency Manager has it in the I state. Write miss transaction with Coherency Manager in the I state. Server-X issues a write to a storage block. The Storage Cache Controller finds that block is not in its Cache and forwards the Transaction to the Coherency Manager. The Coherency Manager finds that block in the I state and sends a “Complete the Transaction” to the Storage Cache Controller on Server-X. The Storage Cache Controller on Server-X completes the write to its cache and sends “Transaction Complete” to the Coherency Manager. The Coherency Manager then sets the state to M with Server-X as the owner and removes the transaction from a Transaction-In-Process queue.

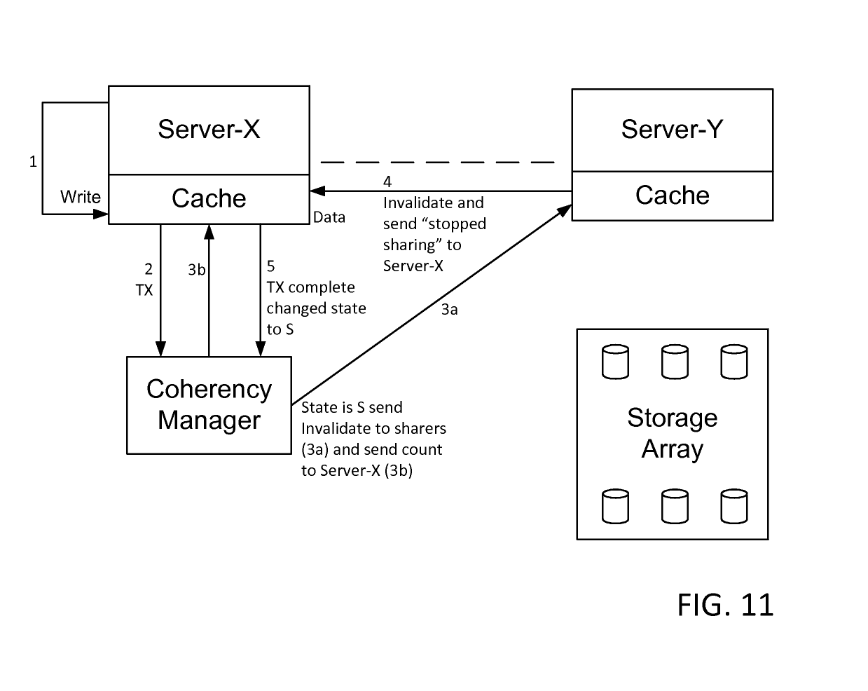

As depicted in FIG. 11, a write is issued by the server and the Storage Cache Controller has no entry for that block (a miss) and the Coherency Manager has it in the S state. Write Miss with Coherency Manager in the S state. Server-X issues a write to a storage block. The Storage Cache Controller finds that block is not in its Cache and forwards the Transaction to the Coherency Manager. The Coherency Manager finds that block in the S state and sends an Invalidate to all of the sharers. The Coherency Manager replies to Server-X with a share count. The sharers respond to the invalidate from the Coherency Manager by invalidating the block and sending a “Stopped Sharing” transaction to the Storage Cache Controller on Server-X. When the Storage Cache Controller on Server-X has decremented the share count to zero it completes the write to its cache and sends “Transaction Complete” to the Coherency Manager. The Coherency Manager then sets the state to M and removes the transaction from a Transaction-In-Process queue.

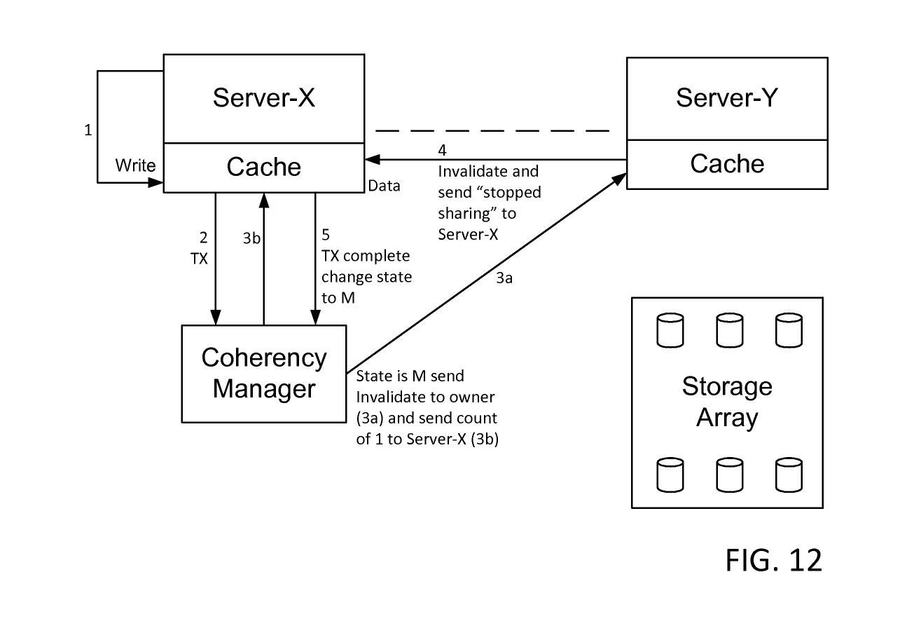

As depicted in FIG. 12, a write is issued by the server and the Storage Cache Controller has no entry for that block (a miss) and the Coherency Manager has it in the M state. Write Miss with Coherency Manager in the M state. Server-X issues a write to a storage block. The Storage Cache Controller finds that block is not in its Cache and forwards the Transaction to the Coherency Manager. The Coherency Manager finds that block in the M state and sends an Invalidate to the owner. The Coherency Manager replies to the Storage Cache Controller on Server-X with a share count of 1. The owning Storage Cache Controller responds to the invalidate from the Coherency Manager by invalidating the block and sending a “Stopped Sharing” transaction to the Storage Cache Controller on Server-X. This decrements the share count to zero and the Storage Cache Controller on Server-X completes the write to its cache and sends “Transaction Complete” to the Coherency Manager. The Coherency Manager then sets the state to M and removes the transaction from a Transaction-In-Process queue.

It can be appreciated that other embodiments will occur to those of average skill in the relevant art. The invention shall be inclusive of all claimant is entitled to under the relevant law by virtue of the drawings and specification and claims included herewith.

What is claimed is:

1. A system for server side distributed storage caching, comprising:
two or more servers, each server equipped with a resident memory cache, and each server connected to each other, to a storage array, and to a coherency manager, wherein each said resident memory cache is enhanced so as to operate with said coherency manager; and wherein said coherency manager is any combination of hardware, software or firmware that can implement computer implementable instructions to maintain coherency of data stored among the resident memory caches and the storage array.

2. A system as in claim 1 wherein said local storage cache controller can be implemented as any of: software running on the server; software running on a network controller card; software running on a storage cache card; hardware on a network controller card; hardware running on a storage cache card.

3. A system as in claim 2, wherein the local storage cache media is any of DRAM, Flask Memory, Phase Change Memory, Magneto-resistive Memory and located on the server or on a storage cache card or on a network card.

4. The system as in claim 1 wherein the connection of said servers and said coherency manager is by any of an Ethernet network, an infiniband network, a fiber channel network.

5. A system for server side distributed storage caching, said system comprising:
a server with a local storage cache manager, where said local cache manager provides a means to locally complete without communicating outside said server write transactions that hit the local cache in the Modified or Exclusive state, and read transactions that hit the local cache in the Modified, Exclusive or Shared states, and
a global coherency manager, where, for a plurality of servers, each server of said plurality having a local cache, and where said plurality of servers are connected via a network, said global coherency manager enables the sharing of the local cache contents of said plurality of servers, thereby enabling applications to move between servers while maintaining a coherent view of storage and maintaining the performance benefits of storage caching, said global coherency manager maintaining a directory with an entry for each storage block that indicates which servers have that block in the shared state or which server has that block in the modified state,
such that combining said local storage cache manager and said global coherency manager enables high performance and low latency in said server side distributed storage caching.

6. A system as in claim 5, wherein said global coherency manager maintains a queue of transactions in flight such that ordering of colliding transactions is resolved based on which transaction entered said queue first, and when an arriving transaction collides with a transaction already in the queue, said arriving transaction is blocked from proceeding until said transaction already in said queue completes.
